(19) United States
(12) Patent Application Publication
(10) Pub. No.: US 2008/0259383 A1
(43) Pub. Date: Oct. 23, 2008

(54) FACSIMILE MACHINE, METHOD, COMPUTER-READABLE MEDIUM, AND COMPUTER DATA SIGNAL

(75) Inventor: Kentaro Fukami, Saitama (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/872,902

(22) Filed: Oct. 16, 2007

(30) Foreign Application Priority Data
Jan. 31, 2007 (JP) 2007-20823

(51) Int. Cl. G06F 3/12

(52) U.S. Cl. 358/1.15

(57) ABSTRACT

A facsimile machine, includes: a receiving unit that receives facsimile image information via a public circuit; an information extraction unit that extracts search information from the facsimile image information received by the receiving unit; an acquisition unit that acquires image information searched from a communication network connected to the facsimile machine, based on the search information extracted by the information extraction unit; and a print unit that prints the image information acquired by the acquisition unit.

### CROSS-REFERENCE TO RELATED APPLICATIONS

This application is based on and claims priority under 35 USC 119 from Japanese Patent Application No. 2007-020823 filed on Jan. 31, 2007.

### BACKGROUND

1. Technical Field

The present invention relates to a facsimile machine, a method, a computer-readable medium, and a computer data signal.

2. Related Art

There is available a facsimile machine for receiving facsimile image information via a communication line.

### SUMMARY

According to an aspect of the invention, there is provided a facsimile machine, including: a receiving unit that receives facsimile image information via a public circuit; an information extraction unit that extracts search information from the facsimile image information received by the receiving unit; an acquisition unit that acquires image information searched from a communication network connected to the facsimile machine, based on the search information extracted by the information extraction unit; and a print unit that prints the image information acquired by the acquisition unit.

### BRIEF DESCRIPTION OF THE DRAWINGS

Exemplary embodiments of the present invention will be described in detail based on the following figures, wherein:

FIG. 1 is a block diagram showing one example of a structure of a facsimile machine according to a first exemplary embodiment;

FIG. 2 is a block diagram showing one example of a functional structure of a controller in the first exemplary embodiment;

FIG. 3 is a diagram showing one example of a print process in the first exemplary embodiment;

FIG. 4 is a flowchart showing one example of an operating procedure followed by the controller in the first exemplary embodiment;

FIG. 5 is a block diagram showing one example of a functional structure of a controller in a second exemplary embodiment;

FIG. 6 is a diagram showing one example of received facsimile image information and image combined information in the second exemplary embodiment; and

FIG. 7 is a flowchart showing one example of an operating procedure followed by the controller in the second exemplary embodiment.

### DETAILED DESCRIPTION

In the following, exemplary embodiments of the present invention will be described with reference to the accompanying drawings.

### First Exemplary Embodiment

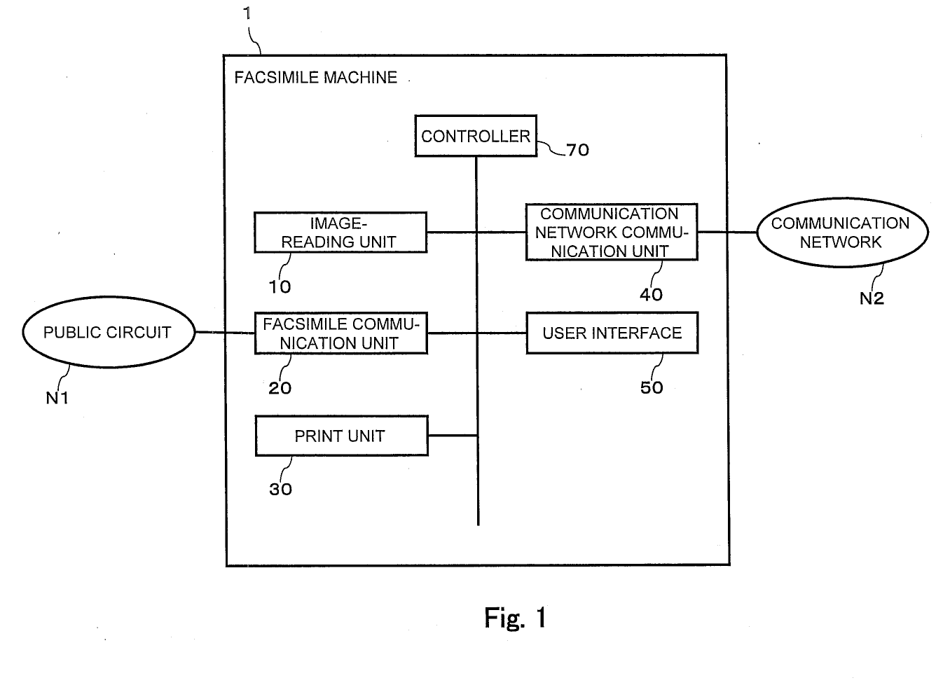

FIG. 1 is a block diagram showing one example of a structure of a facsimile machine 1 according to this exemplary embodiment. The facsimile machine 1 receives facsimile image information via a public circuit N1, and prints the received facsimile image information.

In FIG. 1, the facsimile machine 1 includes an image-reading unit 10, a facsimile communication unit 20, a print unit 30, a communication network communication unit 40, a user interface 50, and a controller 70.

The image-reading unit 10 reads the image of a draft, and produces image information. The image-reading unit 10 is, for example, a scanner for optically reading the image of a draft, by means of a platen method, a sheet through method, or the like, to produce electronic image information.

The facsimile communication unit 20 receives facsimile image information via the public circuit N1, such as a public switched telephone network, an ISDN (Integrated Services Digital Network), or the like. Specifically, the facsimile communication unit 20 receives facsimile image information via the public circuit N1 from the sender's facsimile machine. The facsimile communication unit 20 may additionally have a function for sending facsimile image information via the public circuit N1. The facsimile communication unit 20 is a communication interface, for example, for communicating with other facsimile machines via the public circuit N1.

The print unit 30 prints image information to be printed. The print unit 30 is, for example, a print engine for printing image information onto a print medium, such as paper or the like, by means of an electronic photograph method, an ink-jet method, or the like.

The communication network communication unit 40 communicates with a communication network N2 of a distributed network, such as the Internet, an intranet, or the like, to which many computers are connected for exchanging information. The communication network communication unit 40 is a communication interface for communicating with, for example, a device (for example, a server computer) on the communication network N2.

The user interface (referred to as a “UI unit” in the following) 50 presents information to a user, and receives an operation carried out by the user. The UI unit 50 includes, for example, a display, such as a liquid crystal display or the like, for displaying information, and a reception unit, such as an operation button or the like, for receiving an operation input by the user. The UI unit 50 may be a display of a touch panel type, for example.

The controller 70 carries out a predetermined process, and controls, for example, the entire facsimile machine 1. In this exemplary embodiment, the controller 70 includes hardware resources, such as a CPU (Central Processing Unit), ROM (Read Only Memory), a main memory, an external memory device (a hard disk device, for example), and so forth. The function of the controller 70 is realized by reading a control program recorded in the ROM or the external memory device into the main memory, and executed by the CPU. The control program may be provided as stored in a recording medium, such as a CD-ROM or the like, or alternatively via communication in the form of a data signal. It should be noted that the function of the controller 70 may be realized solely from hardware.

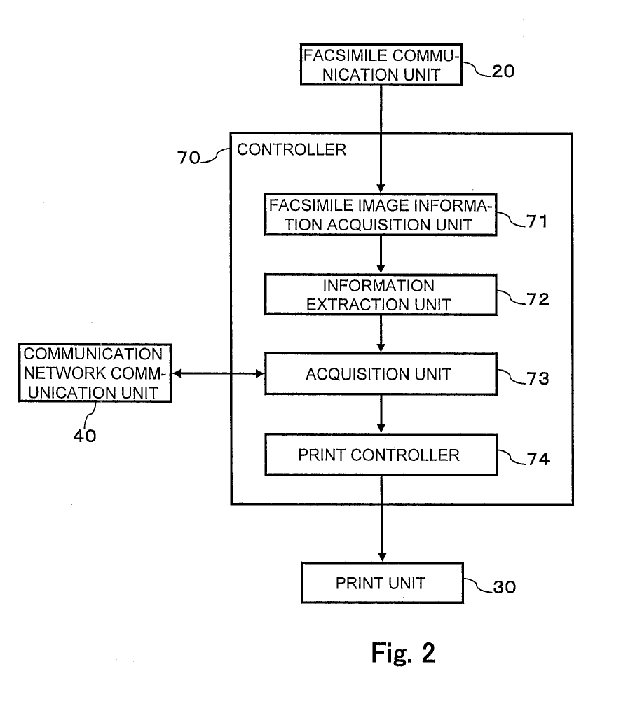

FIG. 2 is a block diagram showing one example of a functional structure of the controller 70 in the first exemplary embodiment. As shown in FIG. 2, the controller 70 includes a facsimile image information acquisition unit 71, an information extraction unit 72, an acquisition unit 73, and a print controller 74.

The facsimile image information acquisition unit 71 acquires facsimile image information received by the facsimile communication unit 20 via the public circuit N1. For example, the facsimile image information acquisition unit 71 controls the facsimile communication unit 20, and receives facsimile image information via the public circuit N1.

The information extraction unit 72 extracts information for use in a search (referred to as “search information” in the following) from the facsimile image information acquired by the facsimile image information acquisition unit 71.

According to one aspect, the information extraction unit 72 extracts, as the above-described search information, location information specifying the location of image information on the communication network N2. Specifically, the information extraction unit 72 extracts location information specifying the location of the image information stored in the image information storage device in the communication network N2. Here, the image information is, for example, a web page, an image file, or the like; the image information storage device is, for example, a server for storing such image information (a Web server or the like, for example); and the location information is, for example, a URL (Uniform Resource Locator), an IP address, or the like, which describes the location of the image information.

According to another aspect, the information extraction unit 72 extracts, as the above-described search information, position information, such as an address or the like, which specifies a position in a map.

In this exemplary embodiment, the information extraction unit 72 recognizes, by means of a character recognition function, and obtains a character string for use in a search, the character string described in facsimile image information, such as a character string of a URL or a character string of an address, for example. A specific URL recognizing method includes a method, for example, for searching a character string, such as “www,” “http,” or the like, to recognize, as a URL, a character line which contains such a character string. A method for recognizing a character string of an address includes a method for searching a character string, such as “prefecture,” “city,” “town,” “village,” or the like, to recognize, as an address, a character line which contains any of such character strings. The information extraction unit 72, however, may employ any method other than the character recognizing method in extraction of search information. For example, the information extraction unit 72 may read a two-dimensional code (a QR code, for example) containing search information from facsimile image information, and restore the search information from the two-dimensional code.

The acquisition unit 73 acquires, via the communication network communication unit 40, image information searched from the communication network N2 connected to the facsimile machine 1, based on the search information extracted by the information extraction unit 72. For example, the acquisition unit 73 retrieves and acquires image information via the communication network communication unit 40 from the communication network N2 connected to the facsimile machine 1, based on the search information extracted by the information extraction unit 72. In this case, the acquisition unit 73 may retrieve image information by itself or cause any device in the communication network N2 other than the facsimile machine 1 to perform the retrieval.

According to one aspect, the acquisition unit 73 acquires image information from the location of the image information in the communication network N2, the location specified by the location information extracted by the information extraction unit 72. Specifically, based on the location information, the acquisition unit 73 acquires image information available in the location specified by the location information, in the image information storage device provided in the communication network N2. For example, the acquisition unit 73 acquires a web page from a Web server in the Internet, based on the extracted URL and by means of the Web browser.

According to another aspect, based on the position information extracted by the information extraction unit 72, the acquisition unit 73 acquires map image information corresponding to the position specified by the position information from the communication network N2. Here, the map image information is, for example, image information showing a map of the area around the position specified by position information. The acquisition unit 73 sends, for example, position information to a map image information providing device provided on the communication network N2, and receives map image information corresponding to the position information from the map image information providing device. Here, the map image information providing device is a server, for example, for providing map image information to the client, in response to position information, such as an address or the like, received from a client, based on the position information. For example, the map image information providing device may be a Web server, and the acquisition unit 73 may receive map image information from the map image information providing device, using a Web browser.

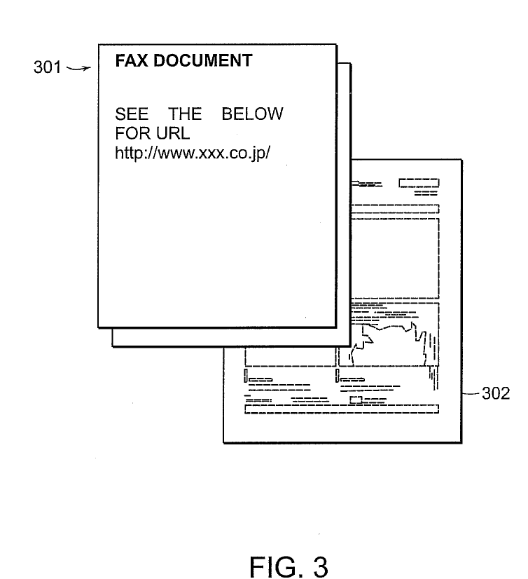

The print controller 74 causes the print unit 30 to print the image information acquired by the acquisition unit 73. That is, the print controller 74 prints, in cooperation with the print unit 30, the image information acquired by the acquisition unit 73. In this exemplary embodiment, the print controller 74 prints the facsimile image information received by the facsimile communication unit 20, and also separately prints the acquired image information. For example, as shown in FIG. 3, the print controller 74 may print the received facsimile image information 301 before printing the acquired image information 302 as a separate page.

In this exemplary embodiment, the controller 70 includes the functions described below, other than those of the above-described blocks 71 to 74, although some or all of the functions described below may be omitted.

The controller 70 includes a function for sending, by means of facsimile, image information read by the image-reading unit 10, by means of a facsimile communication unit 20.

The controller 70 additionally includes a function for causing the UI unit 50 to present, in the form of a list, the extracted search information (for example, location information and position information), and for receiving, via the UI unit 50, designation of one or more pieces of search information among those shown in the list, to be used in acquisition of the image information. Then, in this exemplary embodiment, the acquisition unit 73 acquires image information from the communication network N2, based on the search information designated as described above.

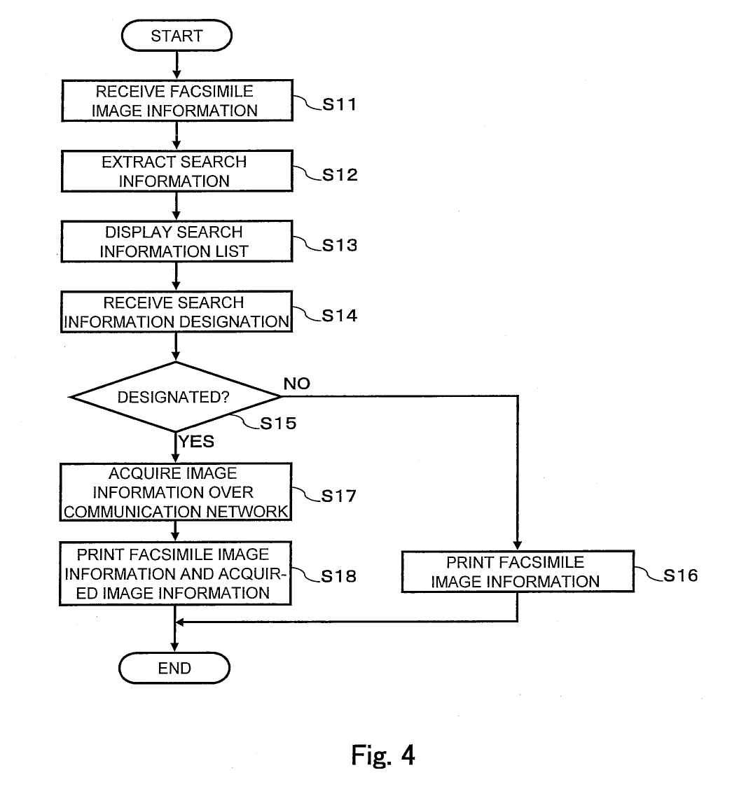

FIG. 4 is a flowchart showing one example of an operating procedure to be followed by the controller 70 in the first exemplary embodiment. In the following, an operation of the controller 70 in this exemplary embodiment will be described with reference to FIG. 4.

The controller 70 receives facsimile image information from the public circuit N1 via the facsimile communication unit 20 (S11).

Thereafter, the controller 70 extracts search information, such as a URL, an address, or the like, from the received facsimile image information (S12).

Subsequently, the controller 70 causes the UI unit 50 to show, in the form of a list, the one or more extracted pieces of search information (S13).

Thereafter, the controller 70 receives designation of one or more pieces of search information among those shown as a list, to be used in acquisition of the image information from the user via the UI unit 50, for example (S14).

Subsequently, the controller 70 determines whether or not there is any designated search information (S15).

When it is determined that there is no designated search information (S15: NO), the controller 70 causes the print unit 30 to print the received facsimile image information (S16).

Meanwhile, when it is determined that there is designated search information (S15: YES), the controller 70 searches and acquires image information from the communication network N2, based on the designated search information (S17), and then first causes the print unit 30 to print the received facsimile image information and then the acquired image information (S18).

As described above, in this exemplary embodiment, search information is extracted from the received facsimile image information, and image information is acquired from the communication network, based on the search information, and printed.

### Second Exemplary Embodiment

A facsimile machine according to this exemplary embodiment is substantially identical with the facsimile machine 1 according to the first exemplary embodiment described above, but differs in that the received facsimile image information is combined with the acquired image information and the resultant image information is printed. In the following, a facsimile machine according to this exemplary embodiment will be described, in which elements common with those of the facsimile machine 1 according to the first exemplary embodiment are denoted by identical reference numerals, and repeated explanations are omitted.

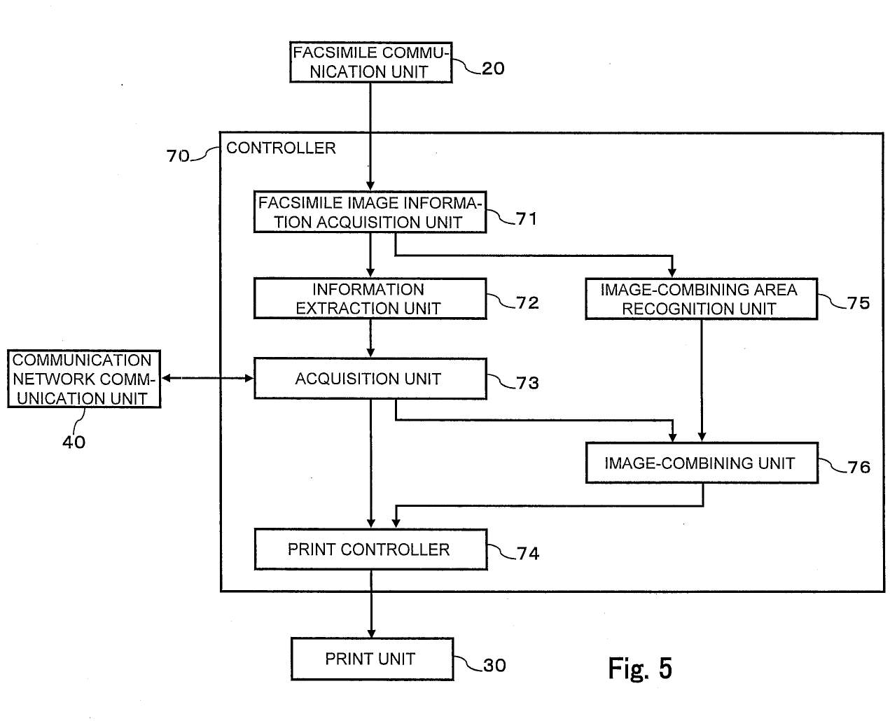

FIG. 5 is a block diagram showing one example of a functional structure of a controller 70 in the second exemplary embodiment.

As shown in FIG. 5, in this exemplary embodiment, the controller 70 further includes an image-combining area recognition unit 75 and an image-combining unit 76, in addition to the function blocks 71 to 74.

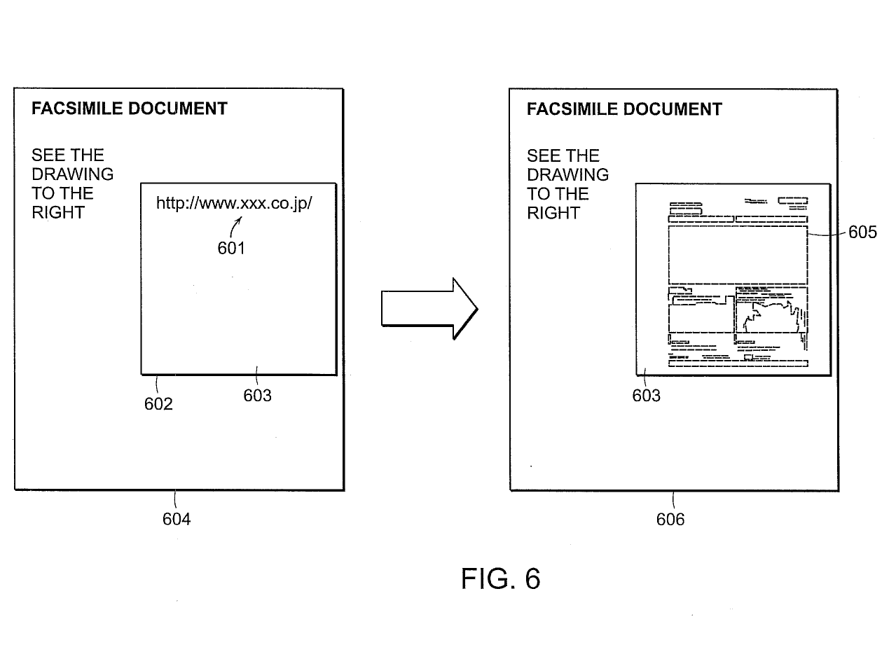

The image-combining area recognition unit 75 recognizes an image-combining area within the facsimile image information, based on the received facsimile image information. In the exemplary embodiment, the image-combining area recognition unit 75 recognizes the area ensured within a frame enclosing the extracted search information (for example, a quadrangular frame) as an image-combining area. For example, in the example shown in FIG. 6, the image-combining area recognition unit 75 recognizes as an image-combining area the area 603 within the frame 602 which encloses the URL character string 601, or search information. However, the method for recognizing an image combining area is not limited to the above-described method, and the image-combining area recognition unit 75 may recognize as an image-combining area the area within a frame, such as a quadrilateral, enclosing a blank area. Also, the image-combining area recognition unit 75 obtains coordinates (for example, the coordinates of four vertexes of the rectangular area) specifying the image-combining area from two dimensional code contained in the facsimile image information, and, based on the coordinates, recognizes an image-combining area. The above-described image-combining area is designated by, for example, the user of the sender facsimile machine, and the information specifying the image-combining area, such as the above-described frame, a two-dimensional code, or the like, may be attached by the user of the sender facsimile machine, for example.

The image-combining unit 76 combines the received facsimile image information and the acquired image information such that the acquired image information is placed in the image combining area recognized by the image-combining area recognition unit 75, to thereby produce image combined information. For example, the image-combining unit 76 pastes the acquired image information 605 onto the image-combining area 603 within the received facsimile image information 604, as shown in FIG. 6, to thereby produce image-combined information 606. In this exemplary embodiment, when combining the received facsimile image information and the acquired image information, the image-combining unit 76 expands or reduces the size of the image information according to the size of the image-combining area.

In this exemplary embodiment, the print controller 74 causes the print unit 30 to print the image information (that is, image-combined information) produced by combining by the image-combining unit 76.

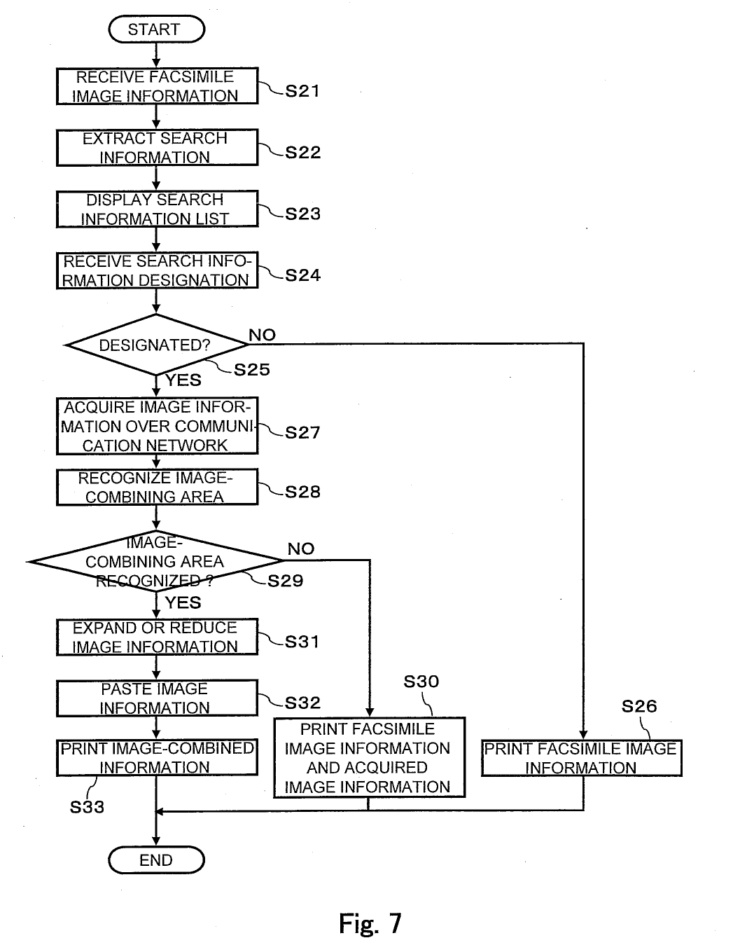

FIG. 7 is a flowchart of one example of an operating procedure to be followed by the controller 70 in the second exemplary embodiment. In the following, with reference to FIG. 7, an operation of the controller 70 in this exemplary embodiment will be described.

Similar to the first exemplary embodiment, the controller 70 receives facsimile image information (S21), extracts search information from the received facsimile image information (S22), causes the UI unit 50 to show, in the form of a list, the extracted search information (S23), and receives the destination of search information via the UI unit 50 from the user, for example (S24). Then, the controller 70 determines whether or not there is designated search information (S25).

When it is determined that there is no designated search information (S25: NO), the controller 70 causes the print unit 30 to print the received facsimile image information (S26).

Meanwhile, when it is determined that there is designated search information (S25: YES), the controller 70 searches and acquires image information from the communication network N2, based on the designated search information (S27).

Subsequently, the controller 70 attempts to recognize an image-combining area ensured within the facsimile image information, based on the received facsimile image information (S28), and determines whether or not the image-combining area is recognized (S29).

When it is determined that no image-combining area is recognized (S29: NO), the controller 70 causes the print unit 30 to first print the received facsimile image information, and then the acquired image information (S30).

Meanwhile, when it is determined that the image-combining area is recognized (S29: YES), the controller 70 reduces or expands the acquired image information according to the size of the recognized image-combining area (S31). Then, the controller 70 pastes the expanded or reduced image information onto the image-combining area of the facsimile image information to thereby produce image-combined information (S32). Further, the controller 70 causes the print unit 30 to print the produced image-combined information (S33).

As described above, in this exemplary embodiment, the received facsimile image information and the acquired image information are combined such that the image information is placed in the image-combining area within the facsimile image information, and the image information resulting from the combining is printed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

For example, after image information is acquired from the communication network N2, based on the search information, the controller 70 may display the acquired image information on the display (for example, the UI unit 50, which is similarly applied in the following) of the facsimile machine. Then, the controller 70 may receive, via the reception unit (for example, the UI unit 50, which is similarly applied in the following) of the facsimile machine, an instruction, for every piece of displayed image information, instructing whether or not to print the image information, and, in response to an instruction instructing to print, causes the print unit 30 to print the instructed image information.

Further, after image information is acquired from the communication network N2, based on the search information, the controller 70 displays the acquired image information in the form of a thumbnail image (a reduced image) on the display of the facsimile machine. Then, the controller 70 receives, via the reception unit of the facsimile machine, designation of one or more pieces of image information to be printed among those displayed as a list, and causes the print unit 30 to print the designated image information.

After the acquired image information is displayed on the display, the controller 70 receives, via the reception unit, an operation to designate a link (that is, location information describing the location of other image information) in the displayed image information to thereby acquire the image information available in the designated link destination in the communication network N2, and displays on the display the image information acquired from the designated link destination. Further, the controller 70 receives, via the reception unit, an instruction instructing whether or not to print the displayed image information, and, in response to an instruction instructing to print, causes the print unit 30 to print the image information.

The controller 70 may record the extracted location information, the extracted position information, or the acquired image information in a computer-readable recording medium, such as a hard disk device, a flash memory, or the like.

It should be noted that the image-reading unit 10 and the facsimile transmission function of the facsimile communication unit 20 may be omitted.

What is claimed is:

1. A facsimile machine, comprising:
a receiving unit that receives facsimile image information via a public circuit;
an information extraction unit that extracts search information from the facsimile image information received by the receiving unit;
an acquisition unit that acquires image information searched from a communication network connected to the facsimile machine, based on the search information extracted by the information extraction unit; and
a print unit that prints the image information acquired by the acquisition unit.

2. The facsimile machine according to claim 1, wherein the information extraction unit extracts, as the search information, location information specifying a location of the image information on the communication network, and, based on the extracted location information, the acquisition unit acquires the image information from the location of the image information on the communication network.

3. The facsimile machine according to claim 1, wherein the information extraction unit extracts, as the search information, position information specifying a position on a map, and, based on the extracted position information, the acquisition unit acquires map image information corresponding to the position specified by the position information from the communication network.

4. The facsimile machine according to claim 1, further comprising:
an image-combining area recognition unit that recognizes, based on the facsimile image information received by the receiving unit, an image-combining area within the facsimile image information; and
an image-combining unit that combines the received facsimile image information and the acquired image information such that the image information is placed in the recognized image-combining area,
wherein
the print unit prints image information obtained by combining by the image-combining unit.

5. The facsimile machine according to claim 2, further comprising:
an image-combining area recognition unit that recognizes, based on the facsimile image information received by the receiving unit, an image-combining area within the facsimile image information; and
an image-combining unit that combines the received facsimile image information and the acquired image information such that the image information is placed in the recognized image-combining area,
wherein
the print unit prints image information obtained by combining by the image-combining unit.

6. The facsimile machine according to claim 3, further comprising:
an image-combining area recognition unit that recognizes, based on the facsimile image information received by the receiving unit, an image-combining area within that facsimile image information; and
an image-combining unit that combines the received facsimile image information and the acquired image information such that the image information is placed in the recognized image-combining area,
wherein
the print unit prints image information obtained by combining by the image-combining unit.

7. A method for printing, by means of a facsimile machine, comprising:
receiving facsimile image information via a public circuit;
extracting search information from the received facsimile image information;
acquiring, based on the extracted search information, image information searched from a communication network connected to the facsimile machine; and
printing the acquired image information.

8. A computer-readable medium storing a program causing a computer to execute a process for printing, using a facsimile machine, the process comprising:
extracting search information from facsimile image information received via a public circuit;
acquiring, based on the extracted search information, image information searched from a communication network connected to the facsimile machine; and
causing a print unit of the facsimile machine to print the acquired image information.

9. A computer data signal embodied in a carrier wave for enabling a computer to perform a process for printing, using a facsimile machine, the process comprising:
extracting search information from facsimile image information received via a public circuit;
acquiring, based on the extracted search information, image information searched from a communication network connected to the facsimile machine; and
causing a print unit of the facsimile machine to print the acquired image information.
